(19) United States
(12) Patent Application Publication
(10) Pub. No.: US 2016/0125061 A1
(43) Pub. Date: May 5, 2016

(54) SYSTEM AND METHOD FOR CONTENT SELECTION

(71) Applicant: PERFORMANCE CONTENT GROUP INC., Toronto (CA)

(72) Inventors: Yakov NEIMAN, North York (CA); Deborah Christine HALL, Toronto (CA); Michael GIRGIS, Scarborough (CA); Oshoma MOMOH, Toronto (CA); Paul Keith COWAN, Toronto (CA); Michael Victor CAMPAGNARO, Toronto (CA); Kyu LEE, Toronto (CA)

(21) Appl. No.: 14/527,001

(22) Filed: Oct. 29, 2014

(51) Int. Cl. G06F 17/30; G06Q 30/02

(52) U.S. Cl. CPC G06F 17/30598; G06Q 30/0251; G06Q 30/0201; G06F 17/30864

(57) ABSTRACT

A server and method for providing a content selection is provided. The server receives content targeting parameters and obtains content items from at least one content site based on the content targeting parameters. The server can further identify content descriptors for the content items and generate a first content cluster from a subset of the content items based on the content descriptors. The server can further generate a second content cluster from a second subset of the content items based on the content descriptors and rank the first and the second content clusters in an order of usefulness. The ranking of the content clusters can be based on at least one of an importance of content, a recentness of the content items and a size of the content cluster.

### FIELD OF INVENTION

The present invention relates generally to network activity data management, and more particularly to a system and method for content accumulation and selection.

### BACKGROUND

Advertising and marketing campaigns are typically targeted at specific audiences. Accordingly, to successfully reach the targeted audience the campaign content and its delivery must be associated with subject matter that is currently relevant to that audience.

A number of different systems and methods exist for trying to reach a target audience. For example, campaign messages may be delivered to devices known to be of interest to the target audience, such as when a device enters a location. Alternatively, messages may be delivered to device accounts with specific known preferences, such as an account that has indicated liking snowboarding.

Existing systems and methods for identifying subject matter of relevance to target audiences, however, typically rely on subject matter related to the actual subject matter of the campaign. Accordingly, such systems do not allow identifying subject matter outside of the knowledge of the creators of the campaign. Moreover, typically, there is little information as to the currency of the information the subject matter identification is based on. Accordingly, there is a need for a system and method for identifying and selecting up-to-date and wide-ranging relevant content for a target audience based on network activity of the target activity.

### SUMMARY

It is an objective to provide a novel server and method for content selection. According to an aspect, a server for performing content selection is provided. The server, comprising a communication subsystem and a processor, receives content targeting parameters and obtains content items from at least one content site based on the content targeting parameters. The server can further identify content descriptors for the content items and generate a first content cluster from a subset of the content items based on the content descriptors. The server can further generate a second content cluster from a second subset of the content items based on the content descriptors and rank the first and the second content clusters in an order of usefulness. The ranking of the content clusters can be based on at least one of an importance of content, a recentness of the content items and a size of the content cluster.

According to another aspect, a method of content selection at a server is provided. The method can comprise:
receiving content targeting parameters;
obtaining content items from at least one content site based on the content targeting parameters;
identifying content descriptors for the content items; and
generating a first content cluster from a subset of the content items based on the content descriptors.

The method can further comprise generating a second content cluster from a second subset of the content items based on the content descriptors and ranking the first and the second content clusters in an order of usefulness. The ranking of the content clusters can be based on at least one of an importance of content, a recentness of the content items and a size of the content cluster. The identifying of content descriptors can further comprise identifying the content descriptors based on at least one of an explicit descriptor source and an implicit descriptor source. The identifying can be based on the implicit descriptor source and the identifying can further comprise inferring the content descriptors from a content of the content items

The method can further comprise selecting the at least one content site based, at least in part, on one or more of the content targeting parameters. The content targeting parameters can include at least one of a content source, a named entity, a target audience description, a target location, a target date, a target user account, a time range for content generation, a target subject matter and a content appropriateness descriptor.

The method can further comprise:
obtaining additional content items from the at least one content site based on the content targeting parameters;
identifying additional content descriptors for the additional content items; and
updating the first content cluster based on the additional content items and the additional content descriptors.

At least one content site can include at least one of social network sites, web sites, advertising sites, auction sites, content classification sites, e-commerce sites and personal information management sites. Moreover, generating the first content cluster can further comprise:
determining a proximity of the content items based on a distance function;
forming the subset of the content items based on the proximity of the content items;
selecting an indicative content item from the subset of the content items; and
identifying a cluster content descriptor based on the selected indicative content item.

### BRIEF DESCRIPTION OF DRAWINGS

FIG. 1 shows a block diagram of an implementation of a system for content selection;

FIG. 2 shows a method of content selection by the system of FIG. 1 in accordance with an implementation;

FIG. 3 shows a block diagram of a user interface in accordance with an implementation;

FIG. 4 shows a block diagram of the system of FIG. 1 in use in accordance with an implementation;

FIG. 5 shows a block diagram of the system of FIG. 1 in use in accordance with an implementation;

FIG. 6 shows a block diagram of the system of FIG. 1 in use in accordance with an implementation; and

FIG. 7 shows a block diagram of the system of FIG. 1 in use in accordance with an implementation.

### DETAILED DESCRIPTION

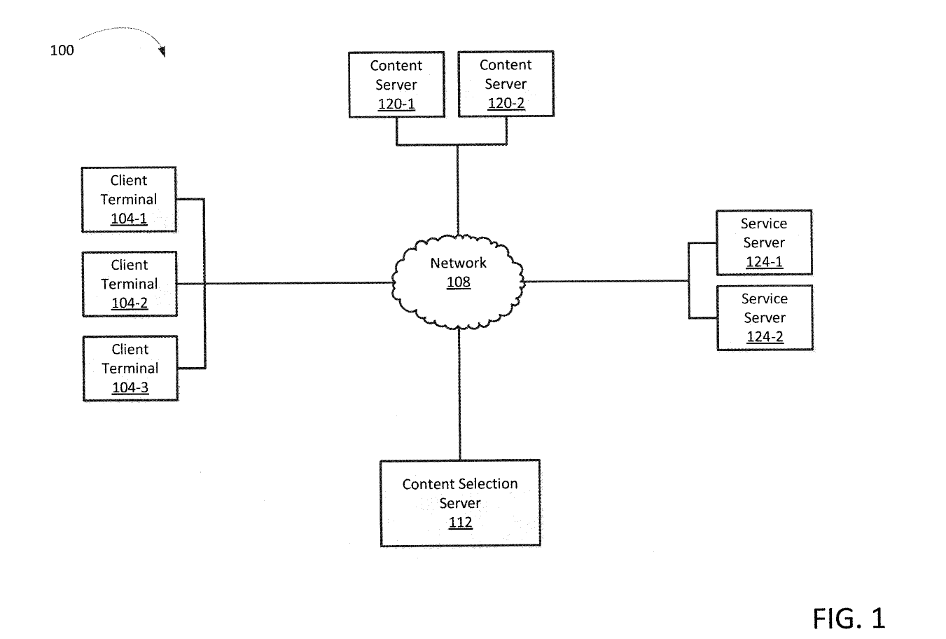

FIG. 1 shows a diagram of a system 100 for content selection. At least one client terminal (the client terminals 104-1, 104-2 and 104-3) can be connected, via the network 108, to a content selection server 112. Collectively, the client terminals 104-1, 104-2 and 104-3 are referred to as the client terminals 104, and generically as the client terminal 104. This nomenclature is used elsewhere herein.

The client terminals 104 can be based on any suitable computing environment, and the type is not particularly limited so long as each client terminal 104 is capable of receiving data from the content selection server 112 and transmitting data to the content selection server 112. In a present implementation, the client terminals 104 are configured to at least execute a web browser that can interact with the web service hosted by the content selection server 112. In other implementations a client terminal 104 may be able to execute applications, widgets and other executables that will now occur to a person of skill in the art.

In specific implementations, the client terminals 104 can be based on any type of client computing environment, such as a desktop computer, a laptop computer, a netbook, a tablet, a smart phone, a PDA, a tablet, other mobile computing device or any other platform suitable for graphical display that is known in the art. For example, the client terminal 104, in various implementations, can take the form of a smart TV, digital displays, electronic eyewear, watches, digital billboards of any size, wearable technology such as glasses, computing environments in refrigerators and cars, other embedded computers and other forms that will now occur to a person of skill. Each client terminal 104 includes at least one processor connected to a non-transitory computer-readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one implementation, memory includes both a non-volatile memory for persistent storage computer-readable instructions and other data, and a non-volatile memory for short-term storage of such computer-readable instructions and other data during the execution of the computer-readable instructions. Other types of computer readable storage medium, which in some implementations may be removable or external to the client terminal 104 are also contemplated, such as secure digital (SD) cards and variants thereof. Other examples of external or removable computer readable storage media include compact discs (CD-ROM, CD-RW) and digital video discs (DVD).

Each client terminal 104 can also include a communications interface operably connected to the processor. The communications interface can allow a client terminal 104 to communicate with other computing devices, for example via the network 108. The communications interface can therefore be selected for compatibility with the network 108. In some implementations of the system 100, the client terminals 104 may be connected to the content selection server 112 directly, without an intervening network 108 such as where the client terminal 104 is connected to the content selection server 112 through a wired universal serial bus (USB) connection or a wireless Bluetooth connection. These connections can be established in addition to or in place of a connection through the network 108.

The network 108 can comprise any network capable of linking the content selection server 112 with the client terminals 104 and can include any suitable combination of wired and/or wireless networks, including but not limited to a Wide Area Network (WAN) such as the Internet, a Local Area Network (LAN), cell phone networks, Wi-Fi™ networks, WIMAX™ networks and the like.

In general terms, the content selection server 112 can comprise any platform capable of processing, transmitting, receiving, and storing data. In a present embodiment, the content selection server 112 is a server configured for performing content selection. The content selection server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage. The content selection server 112 can also include one or more network interfaces, to connect to the network 108 or the client terminals 104. The content selection server 112 can also be configured to include input devices such as a keyboard or pointing device or output devices such as a monitor or a display or any of or all of them, to permit local interaction.

Other types of hardware configurations for the content selection server 112 are contemplated. For example, the content selection server 112 can also be implemented as part of a cloud-based computing solution, whereby the functionality of the content selection server 112 is implemented as one or more virtual machines executing at a single data center or across a plurality of data centers. The content selection server 112 can also be implemented as a distributed server, distributed across multiple computing devices operably connected across a network, for example, the network 108. The software aspect of the computing environment of the content selection server 112 can also include remote access capabilities in lieu of, or in addition to, any local input devices or local output devices.

Any desired or suitable operating system can be used in the computing environment of the content selection server 112. The computing environment can be accordingly configured with appropriate operating systems and applications to effect the functionality discussed herein. Those of skill in the art will now recognize that the content selection server 112 need not necessarily be implemented as a stand-alone device and can be integrated as part of a multi-purpose server or implemented entirely in software, for example as a virtual machine.

The content selection server 112 is operable to receive content selection requests, for example in the form of projects. Projects may be created and populated by user accounts of the content selection server, for example, by accessing the content server 112 through a client terminal 104 or directly through input and output devices connected to the content selection server 112 directly. Projects typically specify content targeting parameters, as well as other project specifics and include a request for content recommendations for use in, for example, marketing or advertising campaigns.

Content targeting parameters are parameters which enable the content selection server to identify and obtain appropriate content for the project. For example, a user account may want to create a marketing campaign for a new soft drink targeted to males aged between 18 and 35, and would like to know content that would be of interest to that target audience. Accordingly, a project can be created by the user account specifying content targeting parameters for the project.

Content targeting parameters can include a specification of the content sources such as types of servers and services and data sources from which to obtain the content, specific named entities (people, places, things, for example) which are of interest to the project, target audience descriptions (e.g. demographic attributes such age, gender, etc.), target locations such as where the campaign might be provided and target dates in the future or past during which the planned marketing campaign is active. Content targeting parameters can also include target user accounts which generate the content, audience user accounts which follow target user accounts, a time range during which the content was generated, shared, or stored, and target subject matter (snow, pop drink, and other keywords or subject areas, for example) to which the content to be obtained relates. Other content targeting parameters will now occur to a person of skill and are contemplated. For example, in variations, content appropriateness descriptors, for example, for age groups, workplaces and others, may also be specified.

The content selection server 112, based on the content targeting parameters, subsequently retrieves a number of content items (obtained content), processes the obtained content to identify content descriptors descriptive of each (or multiple) content item and generates content clusters based on the descriptors and the obtained content. The content items obtained may be any digital content that is retrievable by the content selection server 112. For example, the content may be obtained through the network 108, via communications with other components of the network such as the content servers 120 described below. In variations, content items may be retrieved from content stored or mirrored at the content selection server 112, in addition to or in place of obtaining the content through the network 108. In further variations, the content may be obtained from content aggregation services, such as services which aggregate content from different content services, as opposed to or in addition to the content services themselves.

A content item can be any social network event, for example a Twitter™ status update, Facebook™ post, FourSquare™ check-in, or a user profile update. A content item can also be a web page, a page-view event (i.e. a record indicating a specific web resource was requested at a specific time), a comment posting, a forum posting, a blog post, a timeline indicating the locations and timing of pictures and/or text posted online, logs of activity at a content or service provider (for example, an advertising service or a web analytics service), and any other information available through the network 108. A content item can also be content directly associated with already-obtained content, e.g. web pages, images, audio or video mentioned within social network posts or linked to such posts via a URL. In variations, content items may be provided through input devices such as scanners and cameras. Accordingly, a content item may be pictures of physical places obtained from security cameras, scans of a book or a magazine and other content obtained directly from input devices.

The content descriptors are concepts descriptive of a content item. Content descriptors typically take the form of keywords or key-terms but in variations may be icons, graphics, pictures, audio, video or any other concise content data that is descriptive of a content item. Content descriptors for a content item can be identified based on explicit descriptor sources or implicit descriptor sources such as those inferred from the content item's content. Explicit content descriptor sources can be, for example, metadata that is specified by a content item as being descriptive of that content item's content. Twitter™ hashtags, web page titles, HTML meta-tags and open graph tags, for example, can all serve as explicit content descriptor sources. Alternatively, or in addition, content descriptors may be inferred or acquired based on processing a content item. For example, named entities (people, places and things), sentiments and categories for obtained content can be inferred by processing one or more of the obtained content items. To make the inference, the content selection server 112 can perform natural language analysis, for example, on the text associated with a content item, extracting useful attributes such as people, places and things as descriptors. The content selection server 112 can also perform other types of analysis such as sentiment analysis to extract descriptions of the emotions implied within the text.

The analysis for obtaining inferred content descriptors can be a combination of methodologies performed on the content selection server 112 as well as at the third party web services such as those provided by the service servers 124 described below. For example, content may be processed by the content selection server 112 using known methods such as the text parsing, text tokenization, part-of-speech tagging, and named entity extraction algorithms implemented by open source projects on natural language processing (NLP) such as Apache OpenNLP and Stanford NLP. In variations, analysis may be performed at other servers such as service servers 124, which can include commercial services such as AlchemyAPI™ and Lexalytics Salience™.

Based on the obtained content for the project, and the content descriptors, the content selection server 112 can classify content into categories. For example, content can be classified into broad categories such as sports, entertainment, and politics. Content can also be classified into narrower binary categories such as “Not Safe for Work” and “Spam”. Classification can be performed using various machine learning methods, including Bayesian classification, artificial neural networks, and regression methods. Furthermore, the classification process may take place on the Content Selection Server 112 or on other servers such as Service Servers 124.

Additionally, based on the obtained content for the project, and the content descriptors, the content selection server 112 can group obtained content items together into content clusters. The content clusters are collections of content items which relate closely to each other. For example, content items with similar content as identified based on content descriptors and other content attributes can be collected together to form a content cluster. Then one or more content descriptors for the content items forming the content cluster may be selected as the content descriptors for the content cluster. The content clusters thus represent specific topics of discussion such as “Sochi Olympics”, “2014 world cup soccer”, and “International Imitation Hemingway Competition”. These topics are narrower in scope than the category classifications mentioned above. Thus, in one variation, content clusters can be can be labeled as members of one or more categories.

Content clusters may be generated using various clustering methods such as k-Means, Expectation Maximization, or Hierarchical Clustering. As an illustrative example, all of the content items obtained for a project may be grouped together to form clusters based on their proximity to each other. Proximity can be determined based on a clustering distance function described below. For each content cluster created, an indicative content item can be selected, the indicative content item typically being at, or the closest to, the center of the content cluster, as determined based on the clustering distance function. One or more content descriptors for the selected indicative content item, such as the title of the indicative content item, can then be used as the content descriptor of the cluster. Alternatively, if the selected indicative content item does not have one or more of the appropriate descriptors, then the descriptors from the content item that is next in proximity to the cluster center may be used to fill the missing information. This can be repeated until all the desired content descriptors for the content cluster are obtained or all content items have been examined.

In variations, the content clusters may be updated to further refine the existing clusters or to create new ones, as new content items are obtained for a project. Updates may be done for the entire obtained content. Alternatively, the updates can occur incrementally and new content clusters created (or the existing ones further refined) as additional content items are added to the content obtained for the project.

The clustering distance function can be used to determine proximity of content items. Different distance measures can be used by the clustering distance function to determine proximity. In some implementations, the distance measure can be the similarity of content descriptors. Accordingly, content items with identical descriptors or highly similar descriptors can to be grouped together into one topic cluster. For example, content items with identical or similar named entities may be grouped together. Similarity can be determined using known methods. Alternatively, or in addition, proximity of time at which a content item is generated can be used as a distance measure. For example, content items which were generated close together in time can be grouped together into one cluster. The determination of what is close together in time may be based on a predetermined time duration, for example. As it will be understood other descriptors can also be used as distance measures. For example, content items may be clustered together if they are part of the same discussion thread. As a further example, content items may be clustered if the authors subscribe to each other's posts (follow each other) on one or more social networks. As additional examples, content item locations, for example the location at which content items were generated, can be the basis of clustering content items, such that content items generated within a certain threshold distance, for example, can be clustered. In variations two or more distinct measures of distance may be combined by a clustering distance function when determining proximity.

In some implementations, the content clusters generated may be ranked by being sorted in order of usefulness for the project. Different sorting methods can be used to obtain a ranking. The content clusters may be ranked based on importance to the target audience as identified based on the obtained content. Content clusters can also be ranked from the most recently active (e.g. most recent cluster to gain a new content item) to the least recently active. Accordingly, a recentness of the content items and thus user activity related to the content item can be a basis of ranking content clusters. For example, a user may post a Twitter™ status update on a given day, and another user may retweet the original Twitter™ status update to a friend, the next day. Accordingly, the sharing activity and the content associated with that activity (a retweet for example) is more recent than content generation activity and the content associated with that activity (the original Twitter™ status update, for example). Alternatively, the content clusters can be ranked based on collection size, for example the number of content items within the cluster.

To determine importance, several descriptors and other content attributes can be used. These include, but are not limited to, the age of the content items, the number of content services from which the content of a content cluster is obtained (for example, how many different sources and types of sources, were the content items obtained from), in how many other projects the content cluster arises and how closely a cluster is related to others in the project.

The generated content clusters can subsequently be used to generate content, such as marketing content, based on that the topics represented by particular content clusters. Alternatively, marketing content created may be unrelated to the content clusters but instead can be associated with the content clusters, by, for example, placing advertisements in a documentary whose content is related to the topic represented by a particular content cluster.

Continuing with FIG. 1, the system 100 can also include one or more content servers 120. At least one content server (the content servers 120-1, 120-2 and 120-3) can be connected, via the network 108, to the content selection server 112. Collectively, the content servers 120-1, 120-2 and 120-3 are referred to as the content servers 120, and generically as the content server 120. This nomenclature is used elsewhere herein.

Broadly speaking, a content server 120 can be any server that is operable to provide one or more content services, such as web services, social network services such as Facebook™, Google™, Twitter™ or LinkedIn™ and other networked data services such as serving web sites, auction services, advertising services, e-commerce sites, blog sites, Internet radio and video, personal information management (PIM) services such as email, calendar and contacts services and others that will now occur to a person of skill. For example, in variations, the content services can provide advertising services such as real time bidding. As with the content selection server 112, the content servers 120 can be implemented using various types of hardware and/or software configurations, all of which are contemplated.

In some implementations, the content services also provide mechanisms for accessing the content generated at that service as well as the content's related history. For example, APIs may be supplied that enable requesting and obtaining generated content from a content service. In variations, the request may specify a specific portion of the content available at the content service or the content server 120. For example, a request may specify obtaining only the content matching certain time periods, keywords and/or target accounts by which the content is generated, subject matter and other attributes that will now occur to a person of skill. In one implementation, for example, the content selection server 112 can obtain log information from one or more real time bidding advertising campaigns.

The content selection server 112 can request content from content services in various ways. For example a request for content may be sent based on the content targeting parameters and a response containing the requested content received all at once or in several segments. Alternatively, or in addition, the request may be sent, and the requested content can be received subsequently as a continuous stream for a time period. For example, the request may be placed for content that is up to 5 months old, and content generated within the upcoming five months. Accordingly, the historic content can be received at once as a batch of one or more files, and the future content provided periodically in batch files e.g. once an hour or once a day, or streamed continuously as each relevant content item is generated. In such cases, the content selection server 112 may update the identification of content descriptors and the clustering (and any other appropriate processes) incrementally, as new content items are received. In a further example, as the received content items are processed, additional content requests may be placed based on the received content items. For example, if a content item such as a Twitter™ status update includes a link to a web page, the linked web page may be requested as the content item is processed.

The system 100 can further include service servers 124. At least one service server (the service servers 124-1 and 124-2) can be connected, via the network 108, to the content selection server 112. Collectively, the service servers 124-1 and 124-2 are referred to as the service servers 124, and generically as the service server 124. This nomenclature is used elsewhere herein. As with the content selection server 112, the service servers 124 can be implemented using various types of hardware and/or software configurations, all of which are contemplated.

The service servers 124 provide services related to content such as content analysis services. For example, service servers 124 may process content to identify content descriptors such as keywords descriptive of the content, and cluster the content into content clusters or classify the content into categories. In other variations, service servers 124 can provide aggregation services for grouping together content provided by one or more content servers 120, and optionally calculating useful values such as counts, velocity or the acceleration per unit of time in attributes such as the number of social media references or web links to items in each content collection.

A service server 124 may communicate with one or more other service servers 124 and content servers 120 to perform one or more of its functions. For example, a service server 124 may link with one or more other content servers 120 to further aggregate content. Alternatively, a service server 124 may perform descriptor identification and contact other service servers 124 to perform clustering services.

Variations in the implementation of system 100 will now occur to one of skill in the art, all of which are contemplated as possible implementations of system 100 and are considered within scope. For example, in some variations, one or more service servers 124, can also perform the functionality of a content server 120.

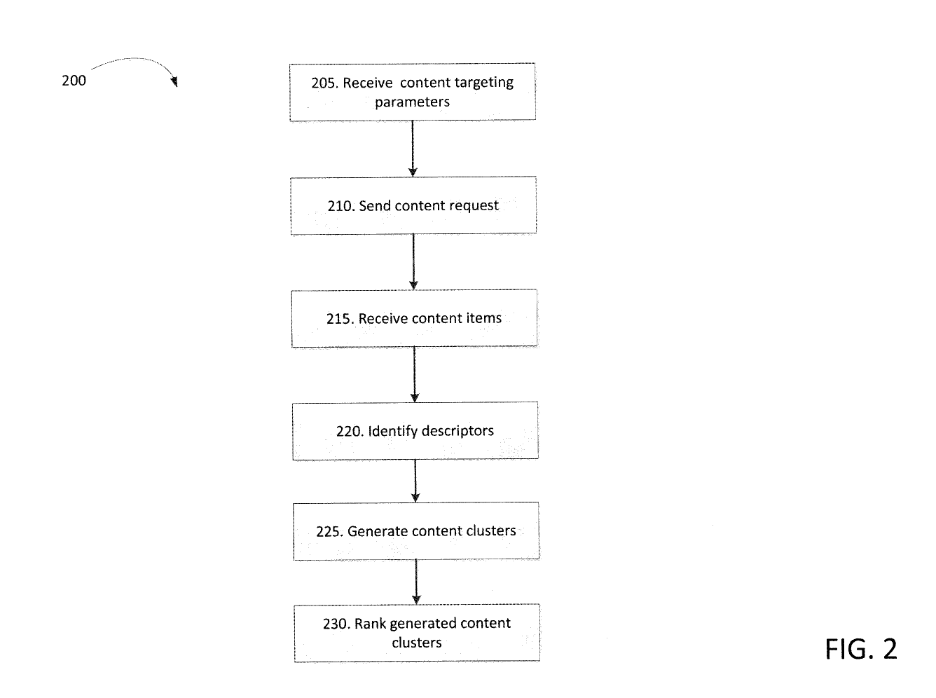

Referring now to FIG. 2, a method of content selection is indicated generally at 200. In order to assist in the explanation of the method, it will be assumed that method 200 is operated using system 100 as shown in FIG. 1. Additionally, the following discussion of method 200 leads to further understanding of system 100. However, it is to be understood that system 100, and method 200 can be varied, and need not work exactly as discussed herein in conjunction with each other, and that such variations are within scope.

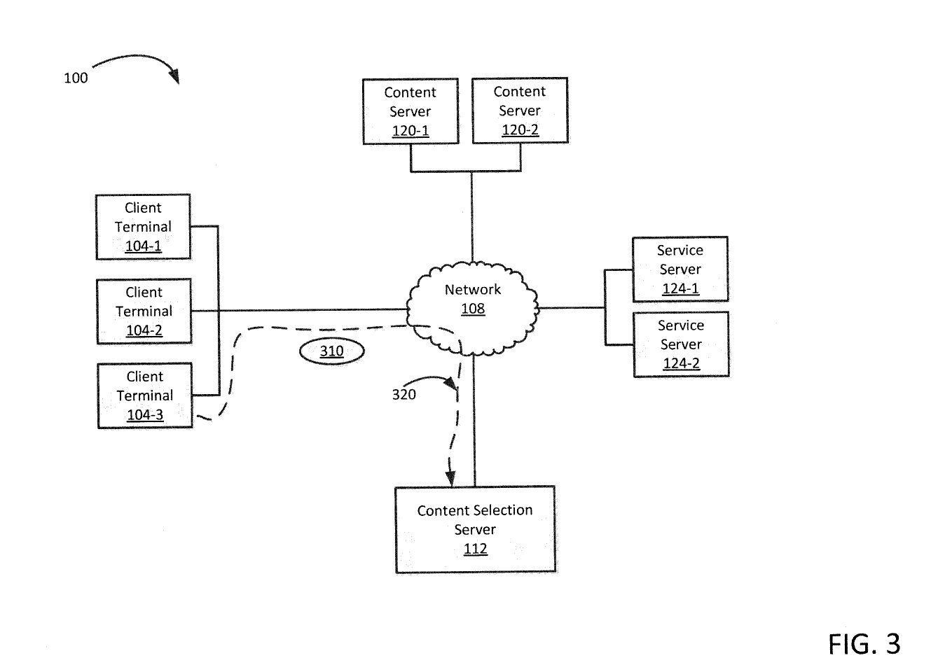

Beginning at 205, content targeting parameters are received. The content targeting parameters may be received through various sources. For example, in one implementation a project can be created by a user account. A user account can allow client terminals 104 to access the features and/or functions of the content selection server 112. As shown in FIG. 3, a user account can be accessed using a client terminal 104, which can communicate with content selection server 112 through the network 108. For example, client terminal 104-3, a desktop computer, could obtain a web page provided by the content selection server 112, the web page designed to acquire and forward to the content selection server 112 information necessary for creating or updating a project, and enter the content targeting parameters 310 at that page, which are transmitted to the content selection server 112, as indicated by the dashed line at 320. In variations, communication with the content selection server 112 can be implemented differently. For example, a client terminal 104 can communicate with the content selection server 112 through an application executing on a client terminal 104 which can access the network 108. Accordingly, project information can be received through the application executing on the client terminal 104 and communicated to the content selection server 112 by the application. In other variations, the content targeting parameters can be provided through the use of input and output devices directly connected to the content selection server 112.

Content targeting parameters can be information which allows the identification of content to be collected and analyzed for a project. In this example implementation, the project is a request for content recommendations for use in association with a marketing and advertisement campaign for a new soft drink. Accordingly, the content target information provided in this example includes a target keyword of “soft drink,” target audience of people between the ages of 18 to 35, and content services Twitter™ and a sports web site. Moreover, target accounts specified include accounts of the members of the Tasha soccer team. A time range of the past four hours is also provided. In some variations, the granularity with which the content targeting parameters are specified may change. For example, a broad category of content services, such as social networking, may be specified, as opposed to specifying a specific content service such as Twitter™.

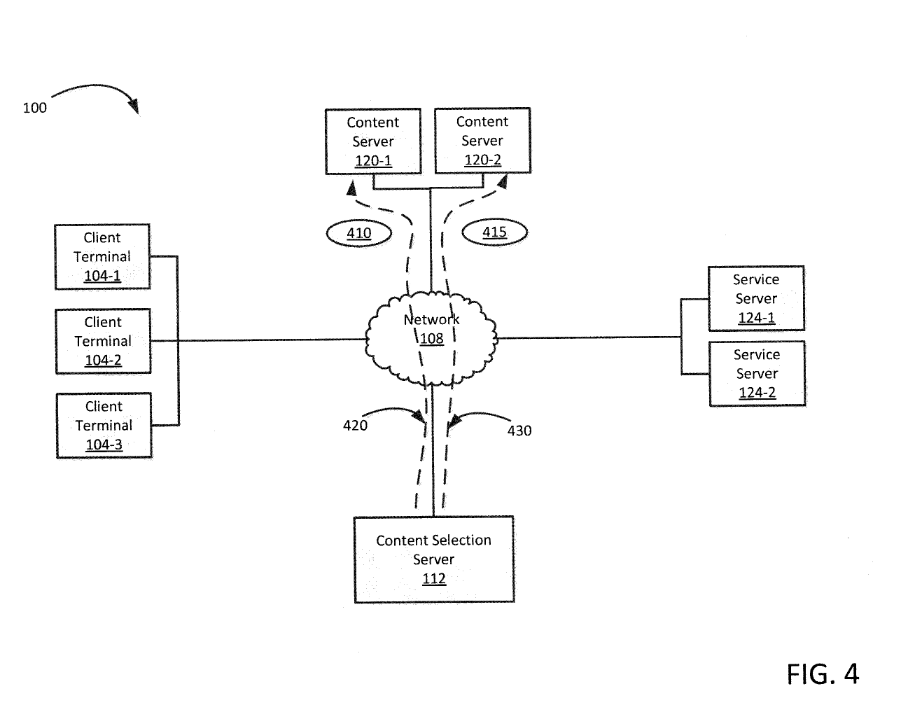

Continuing with the method 200 at 210, content request is sent to appropriate content servers identified based on the content targeting parameters specified at 205. Accordingly, in this illustrative example, as shown in FIG. 4, two requests 410 and 415 are sent, from the content selection server 112 to the content servers 120, as indicated by the dashed lines 420 and 430 respectively. The requests 410 and 415 can be formatted in accordance with various APIs provided by the content servers 120, and the content services provided by those servers 120. The requests 410 and 415 are formed based on the content target parameters and are in effect, a translation of appropriate content target parameters into a format supported by the content service APIs. Moreover, the requests are targeted to specific content servers 120 based on the content target parameters. In this example, the request 410 is a request for the content server 120-1 which provides APIs to the Twifter™ content items. The contents of the request are formatted to request the content items generated by Twitter™ member accounts between the ages of 18 to 35. Moreover, all content items including the keyword “soft drink” as well as all content items generated by accounts belonging to the Tasha soccer team is also requested by the request 410. Finally, a time limit of content items generated in the past four hours is specified. Furthermore, the request 420 is a request for the content server 120-2 which provides APIs to retrieve content from to the sports web site. The content of the requests includes a request for all web pages posted in the last four hours containing the keyword “soft drink”.

Although the requests 410 and 415 are indicated as single requests in this example, it is to be understood by people of skill that this example is illustrative and hence simplified to better illustrate the operations of the system 100. In other implementations, the requests may take various forms including a series of communications between the content selection server and the content servers 120. In yet further variations, APIs may be provided by service servers 124 associated with the content servers 120, and thus the requests can be sent to the service servers 124 associated with a content server 120 rather than a content service 120.

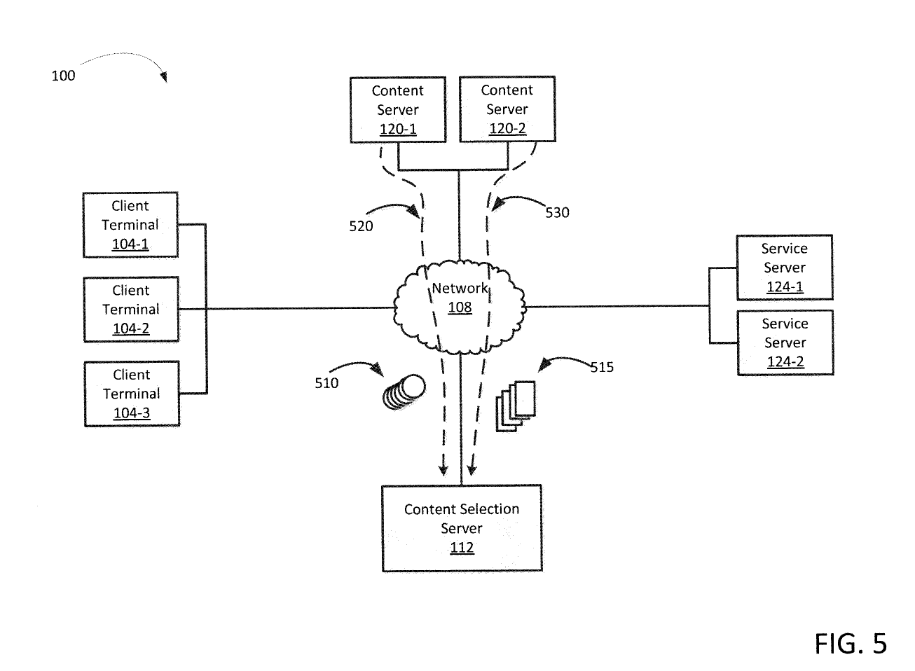

Referring back to FIG. 2, at 215 content items are received at the content selection server 112. As shown in FIG. 5, in this illustrative example 6 Twitter™ status updates 510 (shown as circles) are received from the content server 120-1 and 4 web pages 515 (shown as rectangles) are received from the content server 120-2 as indicated by the dashed lines 520 and 530. The exact method of delivery may vary between implementations. Moreover, in variations, the content may be delivered by servers other than the servers to which the requests were sent.

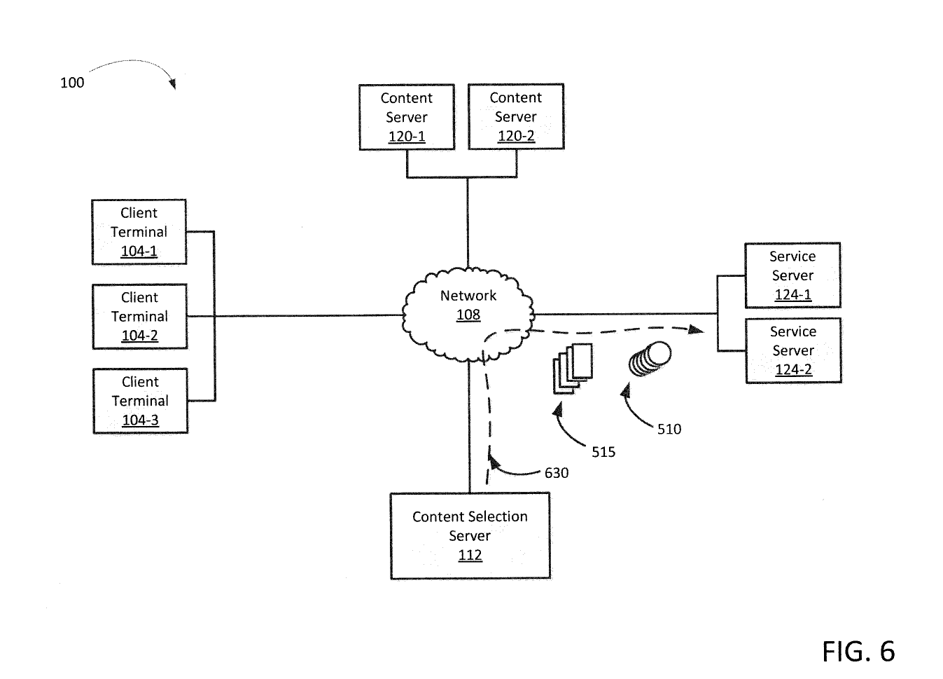

Continuing the method 200, at 220, the received content items are processed to identify descriptors. In this illustrative example, services provided by service servers 124 are utilized to identify descriptors, as shown in FIG. 6. Although in this example, it is shown that the content items (6 Twitter™ status updates 510 and 4 web pages 515) are sent as-is (as indicated by the dashed line 630), in other variations, they may be processed, for example to remove metadata, prior to sending. In further variations the content selection server 112 may perform part of the processing, for example identifying content descriptors based on explicit content indicator sources, and request the service servers 124 provide another portion of the processing, for example inferring descriptors from the content of the content items.

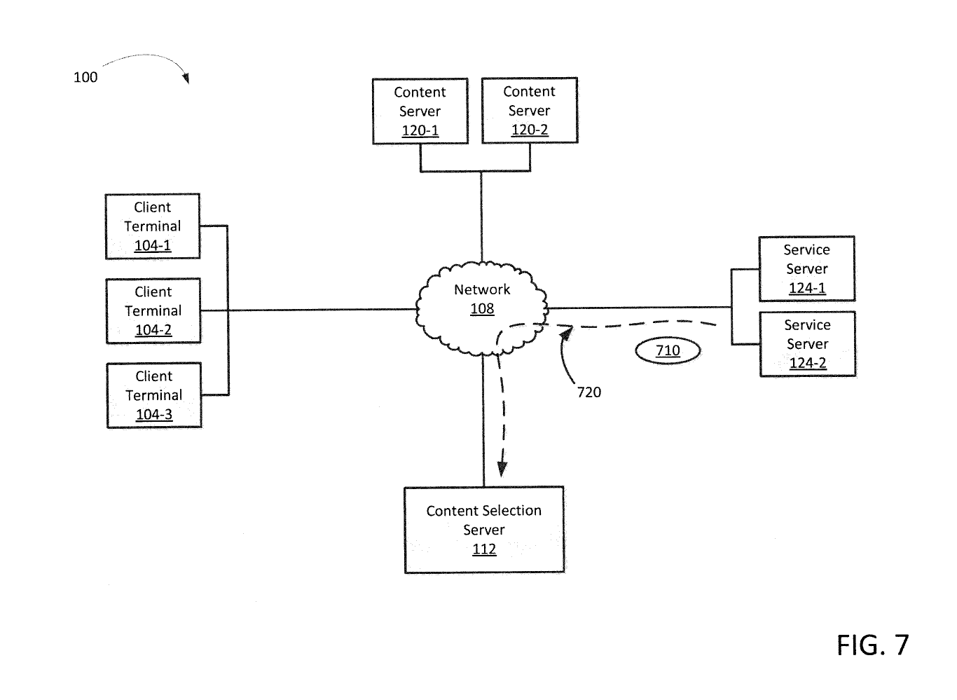

Once the service servers process the received content, the content descriptors 710, as identified, are sent back to the content selection server 112, as indicated by the dashed line 720 in FIG. 7. In variations the content items may also be returned to the content selection server 112, processed for example to tag the content descriptors. In this illustrative example, the content descriptors are identified to be Key West, Fla. and the rock band Asha.

Continuing with the method 200, at 225, the content items received are clustered to form content clusters. In this example, 3 of the 6 Twitter content items and 2 of the 4 web pages are clustered to form a Florida content cluster. Moreover, 4 of the 6 Twitter content items and 1 of the web pages are clustered into an Asha content cluster. One web page is included in a content cluster in which it is the sole member. In variations, a content item may be present in more than one content cluster. In further variations, some content items may not belong to any content clusters, which in further variations may be considered to be content clusters of one item.

At 230, the two clusters are ranked. In this example the ranking is based on the number of content items each cluster contains. Accordingly, the Florida content cluster is ranked higher than the Asha content cluster.

Following the completion of the creation of content clusters, the user account that initiated the project may use the content clusters to design a marketing campaign. For example, advertising content can be designed to include Asha songs. Alternatively, advertising may be placed in connection with web searches for Florida. Accordingly, the method can provide an automated approach to collecting network based account activity information and selecting from that information, content that is appropriate for provided filter criteria.

The above-described embodiments are intended to be examples and alterations and modifications may be effected thereto, by those of skill in the art, without departing from the scope which is defined solely by the claims appended hereto. For example, methods and systems discussed can be varied and combined, in full or in part.

We claim:

1. A method of content selection at a server, the method comprising:
receiving content targeting parameters;
obtaining content items from at least one content site based on the content targeting parameters;
identifying content descriptors for the content items; and
generating a first content cluster from a subset of the content items based on the content descriptors.

2. The method of claim 1 further comprising:
generating a second content cluster from a second subset of the content items based on the content descriptors; and
ranking the first and the second content clusters in an order of usefulness.

3. The method of claim 2 wherein the ranking of the content clusters is based on at least one of an importance of content, a recentness of the content items and a size of the content cluster.

4. The method of claim 1 wherein the identifying content descriptors further comprises:
identifying the content descriptors based on at least one of an explicit descriptor source and an implicit descriptor source.

5. The method of claim 3 wherein the identifying is based on the implicit descriptor source and the identifying further comprises:
inferring the content descriptors from a content of the content items

6. The method of claim 1 further comprising:
selecting the at least one content site based, at least in part, on one or more of the content targeting parameters.

7. The method of claim 6 wherein the content targeting parameters include at least one of a content source, a named entity, a target audience description, a target location, a target date, a target user account, a time range for content generation, a target subject matter and a content appropriateness descriptor.

8. The method of claim 1 further comprising:
obtaining additional content items from the at least one content site based on the content targeting parameters;
identifying additional content descriptors for the additional content items; and
updating the first content cluster based on the additional content items and the additional content descriptors.

9. The method of claim 1 wherein the at least one content site includes at least one of social network sites, web sites, advertising sites, auction sites, content classification sites, e-commerce sites and personal information management sites.

10. The method of claim 1 wherein the generating the first content cluster further comprises:
determining a proximity of the content items based on a distance function;
forming the subset of the content items based on the proximity of the content items;
selecting an indicative content item from the subset of the content items; and
identifying a cluster content descriptor based on the selected indicative content item.

11. The method of claim 10 wherein the distance function is based on at least one of a similarity of the content descriptors, a proximity of a generation time of the content items, a subscription status of an account generating the content items, a proximity of a generated location of the content items and a belonging to a thread of the content items.

12. The method of claim 1 wherein identifying the content descriptors further comprises:
transmitting at least a portion of the content items to a service server; and
receiving an indication of the content descriptors.

13. A content selection server comprising:
a communication subsystem; and
a central processing unit operating in conjunction with the communication subsystem to:
receive content targeting parameters;
obtain content items from at least one content site based on the content targeting parameters;
identify content descriptors for the content items; and
generate a first content cluster from a subset of the content items based on the content descriptors.

14. The server of claim 13 wherein the central processing unit is further operating to:
generate a second content cluster from a second subset of the content items based on the content descriptors; and
rank the first and the second content clusters in an order of usefulness.

15. The server of claim 14 wherein the ranking of the content clusters is based on at least one of an importance of content, a recentness of the content items and a size of the content cluster.

16. The server of claim 13 wherein the operating to identify content descriptors by the processor further comprises the central processing unit operating to:
identify the content descriptors based on at least one of an explicit descriptor source and an implicit descriptor source.

17. The server of claim 13 wherein the central processing unit is further operating to:
select the at least one content site based, at least in part, on one or more of the content targeting parameters.

18. The server of claim 17 wherein the content targeting parameters include at least one of a content source, a named entity, a target audience description, a target location, a target date, a target user account, a time range for content generation, a target subject matter and a content appropriateness descriptor

19. The server of claim 15, wherein the central processing unit is further operating to:
obtain additional content items from the at least one content site based on the content targeting parameters;
identify additional content descriptors for the additional content items; and
update the first content cluster based on the additional content items and the additional content descriptors

20. The server of claim 13 wherein the operating to generate the first content cluster by the processor further comprises the processor operating to:
determine a proximity of the content items based on a distance function;
form the subset of the content items based on the proximity of the content items;
select an indicative content item from the subset of the content items; and
identify a cluster content descriptor based on the selected indicative content item.
